(19) United States
(12) Patent Application Publication
(10) Pub. No.: US 2010/0281117 A1
(43) Pub. Date: Nov. 4, 2010

(54) Method and Apparatus for Managing Business Contacts

(75) Inventors: Antti Ilari Inkeroinen, Espoo (FI); Timo Kristian Miettinen, Espoo (FI); Peter Makki, Espoo (FI); Jukka Sakari Alakontiola, Oulu (FI); Kristian Andreas Luoma, Kiviniemi (FI); Mika Olavi Vuontisjarvi, Oulu (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/432,259

(22) Filed: Apr. 29, 2009

(51) Int. Cl. G06F 17/30; G06F 3/048; G06F 15/16

(52) U.S. Cl. 709/206; 707/737; 715/764; 707/E17.044

(57) ABSTRACT

In accordance with an example embodiment of the present invention, an apparatus comprises at least one processor and at least one memory. The at least one memory includes computer program code. Further, the at least one memory and the computer program code configured to, with the at least one processor, cause the apparatus to perform at least the following associate an organization with a user and update a contact associated with the organization based at least in part on a contact change made by the organization. Further, the apparatus comprise a user interface configured to display the contact to the user based at least in part on at least one of the following: geographic location of the user or the updated contact.

### TECHNICAL FIELD

The present application relates generally to managing business contacts.

### BACKGROUND

An electronic device may have a user interface to use applications. Further, there may be different types of user interfaces. As such, the electronic device facilitates use for different types of user interfaces.

### SUMMARY

Various aspects of examples of the invention are set out in the claims.

According to a first aspect of the present invention, an apparatus comprises at least one processor and at least one memory. The at least one memory includes computer program code. Further, the at least one memory and the computer program code configured to, with the at least one processor, cause the apparatus to perform at least the following associate an organization with a user and update a contact associated with the organization based at least in part on a contact change made by the organization. Further, the apparatus comprise a user interface configured to display the contact to the user based at least in part on at least one of the following: geographic location of the user or the updated contact.

According to a second aspect of the present invention, a method, comprises retrieving data that associates an organization with a user; updating a contact associated with the organization based at least in part on a contact change made by the organization; and displaying the contact to the user based at least in part on at least one of the following: geographic location of the user or the updated contact.

According to a third aspect of the present invention, an apparatus comprises at least one processor and at least one memory. The at least one memory includes computer program code. Further, the at least one memory and the computer program code configured to, with the at least one processor, cause the apparatus to perform at least the following obtain one or more user contacts from an electronic device; determine content associated with the one or more user contacts; obtain content associated with the determined content; and send the content.

According to a fourth aspect of the present invention, a method comprises obtaining one or more user contacts from an electronic device; determining content associated with the one or more user contacts; obtaining content associated with the determined content; and sending the content.

### BRIEF DESCRIPTION OF THE DRAWINGS

For a more complete understanding of example embodiments of the present invention, reference is now made to the following descriptions taken in connection with the accompanying drawings in which:

FIG. 1 is a block diagram depicting an electronic device operating in accordance with an example embodiment of the invention;

FIG. 2 is a block diagram depicting a network for synchronizing contacts in accordance with an example embodiment of the invention;

FIG. 3 is a block diagram depicting an electronic device and a database operating in accordance with an example embodiment of the invention;

FIG. 4 is a screen view depicting a user interface display operating in accordance with an example embodiment of the invention;

FIG. 5 is a screen view depicting another user interface display operating in accordance with an example embodiment of the invention; and

FIG. 6 is a flow diagram illustrating an example method for display a contact in accordance with an example embodiment of the invention.

### DETAILED DESCRIPTION OF THE DRAWINGS

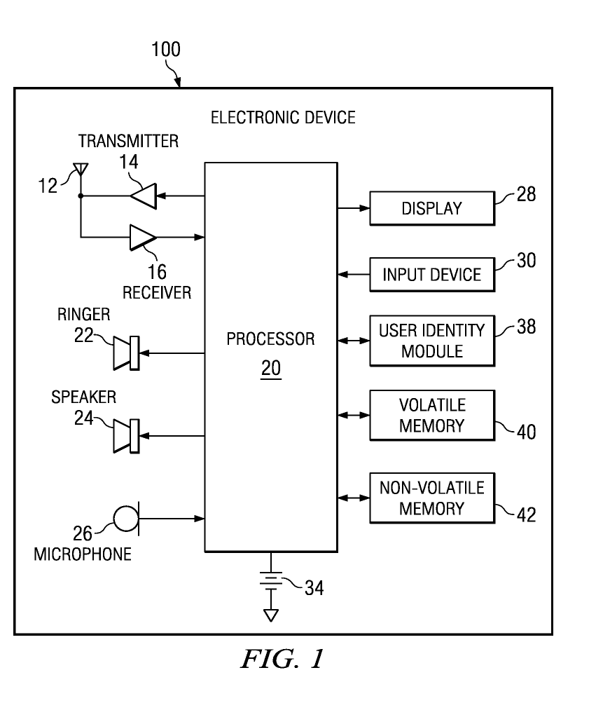

An example embodiment of the present invention and its potential advantages are understood by referring to FIGS. 1 through 6 of the drawings.

FIG. 1 is a block diagram depicting an electronic device 100 operating in accordance with an example embodiment of the invention. In an example embodiment, an electronic device 100 comprises at least one antenna 12 in communication with a transmitter 14, a receiver 16, and/or the like. The electronic device 100 may further comprise a processor 20 or other processing component. The processor 20 may provide at least one signal to the transmitter 14 and may receive at least one signal from the receiver 16. In an embodiment, the electronic device 100 may also comprise a user interface comprising one or more input or output devices, such as a conventional earphone or speaker 24, a ringer 22, a microphone 26, a display 28, and/or the like. In an embodiment, an input device 30 comprises a mouse, a touch screen interface, a pointer, and/or the like. In an embodiment, the one or more output devices of the user interface may be coupled to the processor 20. In an example embodiment, the display 28 is a touch screen, liquid crystal display, and/or the like.

In an embodiment, the electronic device 100 may also comprise a battery 34, such as a vibrating battery pack, for powering various circuits to operate the electronic device 100. Further, the vibrating battery pack may also provide mechanical vibration as a detectable output. In an embodiment, the electronic device 100 may further comprise a user identity module (UIM) 38. In one embodiment, the UIM 38 may be a memory device comprising a processor. The UIM 38 may comprise, for example, a subscriber identity module (SIM), a universal integrated circuit card (UICC), a universal subscriber identity module (USIM), a removable user identity module (R-UIM), and/or the like. Further, the UIM 38 may store one or more information elements related to a subscriber, such as a mobile subscriber.

In an embodiment, the electronic device 100 may comprise memory. For example, the electronic device 100 may comprise volatile memory 40, such as random access memory (RAM). Volatile memory 40 may comprise a cache area for the temporary storage of data. Further, the electronic device 100 may also comprise non-volatile memory 42, which may be embedded and/or may be removable. The non-volatile memory 42 may also comprise an electrically erasable programmable read only memory (EEPROM), flash memory, and/or the like. In an alternative embodiment, the processor 20 may comprise memory. For example, the processor 20 may comprise volatile memory 40, non-volatile memory 42, and/or the like.

In an embodiment, the electronic device 100 may use memory to store any of a number of pieces of information and/or data to implement one or more features of the electronic device 100. Further, the memory may comprise an identifier, such as international mobile equipment identification (IMEI) code, capable of uniquely identifying the electronic device 100. The memory may store one or more instructions for determining cellular identification information based at least in part on the identifier. For example, the processor 20, using the stored instructions, may determine an identity, e.g., cell id identity or cell id information, of a communication with the electronic device 100.

In an embodiment, the processor 20 of the electronic device 100 may comprise circuitry for implementing audio feature, logic features, and/or the like. For example, the processor 20 may comprise a digital signal processor device, a microprocessor device, a digital to analog converter, other support circuits, and/or the like. In an embodiment, control and signal processing features of the processor 20 may be allocated between devices, such as the devices describe above, according to their respective capabilities. Further, the processor 20 may also comprise an internal voice coder and/or an internal data modem. Further still, the processor 20 may comprise features to operate one or more software programs. For example, the processor 20 may be capable of operating a software program for connectivity, such as a conventional Internet browser. Further, the connectivity program may allow the electronic device 100 to transmit and receive Internet content, such as location-based content, other web page content, and/or the like. In an embodiment, the electronic device 100 may use a wireless application protocol (WAP), hypertext transfer protocol (HTTP), file transfer protocol (FTP) and/or the like to transmit and/or receive the Internet content.

In an embodiment, the electronic device 100 may be capable of operating in accordance with any of a number of a first generation communication protocol, a second generation communication protocol, a third generation communication protocol, a fourth generation communication protocol, and/or the like. For example, the electronic device 100 may be capable of operating in accordance with second generation (2 G) communication protocols IS-136, time division multiple access (TDMA), global system for mobile communication (GSM), IS-95 code division multiple access (CDMA), and/or the like. Further, the electronic device 100 may be capable of operating in accordance with third-generation (3 G) communication protocols, such as Universal Mobile Telecommunications System (UMTS), CDMA2000, wideband CDMA (WCDMA), time division-synchronous CDMA (TD-SCDMA), and/or the like. Further still, the electronic device 100 may also be capable of operating in accordance with 3.9 generation (3.9 G) wireless communication protocols, such as Evolved Universal Terrestrial Radio Access Network (E-UTRAN) or the like, or wireless communication projects, such as long term evolution (LTE) or the like. Still further, the electronic device 100 may be capable of operating in accordance with fourth generation (4 G) communication protocols.

In an alternative embodiment, the electronic device 100 may be capable of operating in accordance with a non-cellular communication mechanism. For example, the electronic device 100 may be capable of communication in a wireless local area network (WLAN), other communication networks, and/or the like. Further, the electronic device 100 may communicate in accordance with techniques, such as radio frequency (RF), infrared (IrDA), any of a number of WLAN techniques. For example, the electronic device 100 may communicate using one or more of the following WLAN techniques: IEEE 802.11, e.g., 802.11a, 802.11b, 802.11g, 802.11n, and/or the like. Further, the electronic device 100 may also communicate, via a world interoperability, to use a microwave access (WiMAX) technique, such as IEEE 802.16, and/or a wireless personal area network (WPAN) technique, such as IEEE 802.15, BlueTooth (BT), ultra wideband (UWB), and/or the like.

It should be understood that the communications protocols described above may employ the use of signals. In an example embodiment, the signals comprises signaling information in accordance with the air interface standard of the applicable cellular system, user speech, received data, user generated data, and/or the like. In an embodiment, the electronic device 100 may be capable of operating with one or more air interface standards, communication protocols, modulation types, access types, and/or the like. It should be further understood that the electronic device 100 is merely illustrative of one type of electronic device that would benefit from embodiments of the invention and, therefore, should not be taken to limit the scope of embodiments of the invention.

While embodiments of the electronic device 100 are illustrated and will be hereinafter described for purposes of example, other types of electronic devices, such as a portable digital assistant (PDA), a pager, a mobile television, a gaming device, a camera, a video recorder, an audio player, a video player, a radio, a mobile telephone, a traditional computer, a portable computer device, a global positioning system (GPS) device, a GPS navigation device, a GPS system, a mobile computer, a browsing device, an electronic book reader, a combination thereof, and/or the like, may be used. While several embodiments of the invention may be performed or used by the electronic device 100, embodiments may also be employed by a server, a service, a combination thereof, and/or the like.

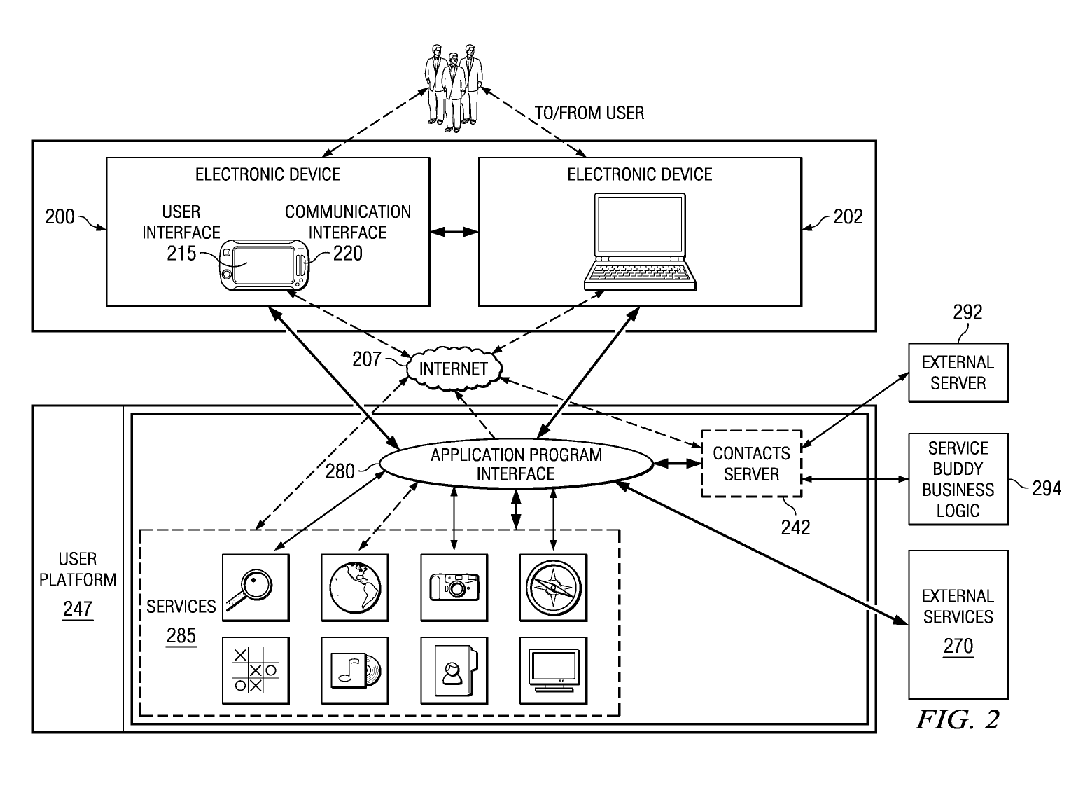

FIG. 2 is a block diagram depicting a network for synchronizing contacts in accordance with an example embodiment of the invention. In an example embodiment, electronic devices 200, 202 may be in communication with a user platform 247, via a network, for example Internet 207. Further, the electronic devices 200, 202 may comprise a user interface, such as user interface 215, a communication interface 220, and/or a processor.

In an example embodiment, a processor, such as processor 20 of FIG. 1, may be configured to execute instructions stored in a memory device of the electronic device 200, such as memory devices 40, 42 of FIG. 1. In an embodiment, the processor may be a microprocessor, various other processing elements, such as an integrated circuit, and/or the like. For example, the processor may be an application specific integrated circuit (ASIC), a field programmable gate array (FPGA), and/or the like.

In an embodiment, the memory device may be configured to buffer input data for processing by the processor. In an alternative embodiment, the memory device may be configured to store instructions for execution by the processor. In another alternative embodiment, the memory device may be one of a plurality of databases. Further, the memory device may store at least one contact widget in real time or otherwise dynamic manner. In an embodiment, the at least one contact widget may comprise one or more of the following information: a mobile number, a name, a short message service contact, a multimedia messaging service contact, an email address, a chat identifier, a location, an Internet protocol address, a voice over Internet protocol client, user profile information, one or more shared files, e.g., documents, photos, media content, and/or the like, or combination thereof, and/or the like. In an embodiment, a widget may be an element of a graphical user interface (GUI). Further, the widget may comprise contact information.

In an example embodiment, user platform 247 may be in communication with electronic devices 200, 202. In an example embodiment, the user platform 247 may comprise one or more services 285, a contacts server 242, and/or an application program interface (API) 280. For example, the contacts server 242 may store one or more contact widgets. In an embodiment, the contacts server 242 may be a web server, database server, file server, and/or the like. Further, the contacts server 242 may comprise a memory device, a processor, and/or a communication interface for communicating over the Internet 207 to, for example communication interface 220 of the electronic device 200. In an example embodiment, the contacts server 242 may be in communication with an external server 292 and/or a service buddy business logic 294.

In an embodiment, the electronic device 200 may use the communication interface 220 to communicate with the contacts server 242, a user platform 247, and/or external services 270 via a network, such as Internet 207. For example, the communication interface 220 may be configured to receive at least one updated contact widget from a server, such as user platform 247, service 285, external services 270, and/or the like. Further, the communication interface 220 may transfer the at least one updated contact widget to electronic device 200 and/or electronic device 202 for synchronization. For example, the communication interface 200 transfers updated contact information for an organization. In an alternative embodiment, the electronic device 200 may communicate or receive the updated contact widget, via the API 280, to the contacts server 242, services 285, external services 270, and/or the like via the Internet 207.

In an example embodiment, the contacts server 242 is communicatively coupled, via an interface, to an external server 292. In an example embodiment, a external server 292 comprises an interface to the Internet. Further, external server 292 may comprises a database entry relating to one or more Uniform Resource Locations (URLs), such as www.nike.com, www.wilson.com, www.finnair.com, www.ovi.com, and/or the like. In an embodiment, the external server 292 may comprise a record related to one or more phone numbers associated with, for example, the one or more URLs. Further the external server 292 comprises information related to the phone number, URL, and/or the like, for example, hours of operation. In an embodiment, the information related to the phone number, URL, and/or the like, is customizable based at least in part on an entity's needs. For example, the entity may be a commercial company or an association sharing information.

In an example embodiment, the contacts server 242 comprises a plurality of user contacts, e.g., user phonebooks. In an embodiment, the electronic device 200 synchronizes the contacts over a carrier with the contacts server 242. If the contact number, domain name, and/or the like are recognized by the contacts server 242, then the contacts server 242 may determine whether there is respective number or URL in external server 292. If the contacts server 242 determines there is no respective number or URL, the contacts server 242 is configured to request a suggestion from the external server 292. In such a case, the external server 292 suggests to the contacts server 242 to add more information from the number or URL as phone book information for better association.

In an example embodiment, the contacts server 242 comprises a contact with a custom contact field, such as information downloaded from the Internet. For example, the information may be related to a respective URL for a user's web page under associated with the user's phone number. During synchronization between electronic device 200 and contacts server 242, selected information may be synchronized to include information in contacts server 242 and/or the internet. In such a case, it is possible to synchronize web page content, which is not normally synchronized. It should be understood that the information shared between the external server 292 and contacts server 242 may be based at least in part on the user's content, e.g. a user located in Helsinki, Finland may receive information in Finnish. In such a case, the location specific information is sent to the external server 292 which associates the respective data to the user.

In an example embodiment the contacts server 242 is configured to issue a query to the external server 292 for one or more addresses of an entity. In an embodiment, the electronic device 200 may display the one or more addresses from the contacts server 242 based at least in part on user service location, e.g. country based and/or community based rules. For example, a user is in Oulu and receives an address for a gas station in the Oulu area. In an embodiment, an address search query is generated to a map application. The contacts server 242 is configured to receive information about the map indicating the location of the entity from the search query. In an embodiment, a link to a map application may be available via a service so that when user may easily obtain the resulting information. It may be useful to help user in this context if the user's current location is a starting point and the location of the entity as a destination automatically.

In an embodiment, at least one contact widget may be synchronized between one of the electronic device 200, 202 and the user platform 247 in real time. For example, the contacts server 242 may be configured to synchronize the at least one contact widget when a contact widget has been changed. Further, the contacts server 242 may be configured to update the at least one contact widget in real time. For example, if one contact widget has changed on the contacts server 242, the electronic device 200 may synchronize the at least one contact widget between the contacts server 242 and the electronic device 200 in real time, e.g., as the update occurs.

In another embodiment, the services 285 may be configured to synchronize the at least one contact widget when a contact widget has been changed. Further, the services 285 may be configured to update the at least one contact widget in real time. For example, if one contact widget has changed on the contacts server 242, the electronic device 200, or services 285 may synchronize the at least one contact widget between the contacts server 242, services 285, and/or the electronic device 200 in real time. In this way, the electronic device 200, contacts server 242, and/or services 285 maintain substantially the same contact widgets in real time.

In an embodiment, the user platform 247 may be used to facilitate storing, retrieving, computing, transmitting, receiving, and/or the like, at least one contact widget. Further, the user platform 247 may be embodied as an electronic device, such as the electronic device 100 of FIG. 1, the electronic device 200, the electronic device 202, and/or the like. The user platform 247 may also be configured to communicate with one or more users using the contact widgets. For example, the user platform 247 may be configured to allow a user of electronic device 200 to contact a second user via a communication, messaging system, communications protocol, and/or the like, e.g., emails, multimedia messaging service (MMS), short message service (SMS) messages, phone calls, and/or the like, using contact information in the contact widget. It should be understood that MMS may be a messaging system, which may allow a user to send messages comprising multimedia objects, e.g., images, audio, video, rich text. Further, a SMS may be a communications protocol to allow the interchange of short text messages between electronic devices.

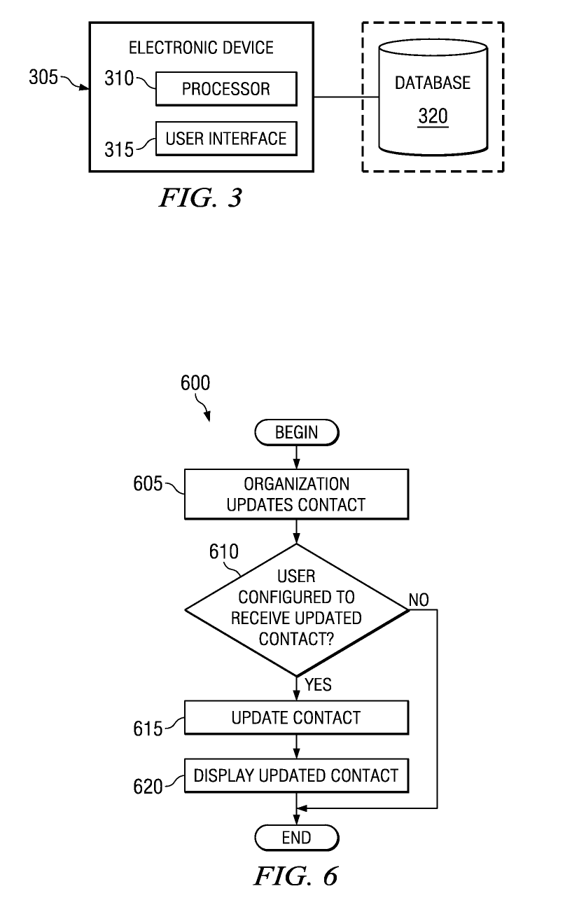

FIG. 3 is a block diagram depicting an electronic device 305 and a database 320 operating in accordance with an example embodiment of the invention. In an example embodiment, the electronic device 305 comprises at least one processor 310, and a user interface 315. In an example embodiment, the at least one processor 310 comprises at least one memory. The memory may comprise computer program code. In an embodiment, the computer program code is configured to, with the at least one processor, cause the electronic device 305 to perform at least the following associate an organization with a user and/or update a contact associated with the organization based at least in part on a contact change made by the organization. In an alternative embodiment, the at least one memory may be separate from the processor 310.

In an embodiment, the electronic device 305 may be in communication with the database 320. In an example embodiment, the electronic device 305 is similar to the electronic device 100 of FIG. 1 and the processor 310 is similar to the processor 20 of FIG. 1. In an alternative embodiment, the electronic device 305 is different than the electronic device 100 of FIG. 1 and the processor 310 is different than the processor 20 of FIG. 1.

In an example embodiment, the processor 310 is configured to associate an organization with a user. For example, the processor 310 associated a user to a particular business based at least in part on the user adding a business contact. Further, the processor 310 is configured to update a contact, such as a business contact, associated with the organization based at least in part on a contact change made by the organization. For example, the organization updates location information or promotional information, which the processor 310 updates. In an example embodiment, the business contact comprises an updatable logo or location. It should be understood that the electronic device 200, the contacts server 242, the external server 292, and/or the like are capable of performing at least the following: associating an organization with a user or updating a contact, such as a business contact, associated with the organization based at least in part on a contact change made by the organization.

In an example embodiment, the processor 310 is further configured to receive a message from the organization. In an embodiment, the message is associated with a user interest. For example, the message relates to a hobby of the user. In an alternative embodiment, the message is at least one of the following: an advertisement, a promotion, a combination thereof, and/or the like. In an alternative embodiment, the message is associated with a user's content. For example, the message relates to an Internet web page associated with a contact in the user's phone book. In such a case, the user may receive content from the Internet web page, such as an advertisement, a promotion, a combination thereof, and/or the like.

In an example embodiment, the processor 310 is further configured to allow a user to enable or disable the message. Further, the processor 310 may be configured to allow a user to configure a frequency to receive the message. For example, the user may configure daily updates. Further still, the processor 310 may be configured to allow a user to select one or more organizations to receive messages from.

In an example embodiment, the user interface 315 is configured to display the contact, such as the business contact, to the user based at least in part on at least one of the following: geographic location of the user or the updated contact. In an example embodiment, the user interface 315 is further configured to display the updated contact in a business contact on a phonebook. In an embodiment, the user interface 315 is further configured to display the message from the business contact.

In an embodiment, the business contact on the electronic device 305 may be synchronized with the database 320. For example, the user initiates synchronization. In such a case, the user interface 315 may display a request for the user to receive an updated business contact from the database 320. After confirming, the user receives an updated business contact and/or message related to the business contact. A technical effect of one or more of the example embodiments disclosed herein is receiving updated business contacts. It should be understood that the database 320 may be located in the electronic device 305. In an alternative embodiment, the database 320 may be part of a contacts server, such as contacts server 242 of FIG. 2.

In an example embodiment, a user synchronizes contacts with a service, such as the one or more services 285 on the user platform 247 of FIG. 2. In an example embodiment, the service determines whether business contacts are present on the electronic device 305. In an embodiment, the service sends a request to the user to determine if the user would like an update for a business contact. In an alternative embodiment, the service sends the user the update based on a prior configuration, such as receive all contacts. In yet another alternative embodiment, the service sends the user an update regardless of a confirmation status. In still yet another embodiment, the service sends a request to an external server 292, such as a business contacts database, to determine if a contact number of the user matches a contact number in the external server 292. In such a case, the service provides information from the external server 292 to the user. In an embodiment, the user interface 315 is configured to display the update to the user. For example, the user interface 315 display an offer related to the business contact.

In an example embodiment, the user interface 315 displays the business contact as part of a service buddy. In an example embodiment, the service buddy comprises a business contact. Example service buddies include an operator buddy related to brand loyalty, selling services, customer relationship management, and/or the like, an adplaces buddy related to discovery, triggered ads, sales of physical goods, and/or the like, a care buddy related to brand loyalty, customer relationship management, and/or the like, a celebrity buddy related to brand loyalty, sales of digital goods, and/or the like, a music buddy related to brand loyalty, sales of digital goods, and/or the like, a survey buddy related to piloting, customer relationship management, and/or the like, and a utility buddy related to any number of electronic device features.

In an example embodiment, the electronic device 305 comprises a contacts server, such as contacts server 242 of FIG. 2. In an example embodiment, the contacts server is configured to obtain one or more user contacts from an electronic device. For example, look-up the phone book on the electronic device 305. Further, the contacts server is configured to determine content associated with the one or more user contacts. For example, the contacts have content related to swimming. The contacts server is also configured to obtain content associated with the determined content. Further, the contacts server is configured to send the content.

The contacts server may be in communication with service buddy business logic, such as service buddy business logic 294 of FIG. 2. In an example embodiment, the service buddy business logic 294 is a service configured to determine content based as least in part on the content in the user's electronic device, such as electronic devices 200, 202. In an embodiment, the service buddy business logic 294 determines content based at lest in part on at least one of the following: user location, music user is now listening to, user calendar status, direct or derived data from an accelerometer, e.g., moving/not moving, walking, cycling, driving, and/or the like, temperature, lightning, key lock, call status, NW usage status, battery level, pulse (heart beat), application the user is currently using, local time, and/or the like. It should be understood the content may be based on the electronic device 305. For example, the temperature where the electronic device 305 is located.

In an example embodiment, the service buddy business logic 294 may provide more detailed information in socially convenient situation manner. For example, the service buddy business logic 294 may provide a suggestion relating to location. For example, there is a rock café nearby rather than a piano bar because the user queries for a café while listening to rock music. Further, the service buddy business logic 294 may provide more customizable information, such as large pictures and sound while driving and/or moving fast and more elaborate and detailed material while user is stationary.

In an example embodiment, the service buddy is updated based at least in part on the service buddy business logic 294 suggestion. For example, if a user is associated with a particular business then the service buddy provides a more geographically convenient location for the user based on the current location. A technical effect of one or more of the example embodiments disclosed herein is use of a service buddy associated with business contacts.

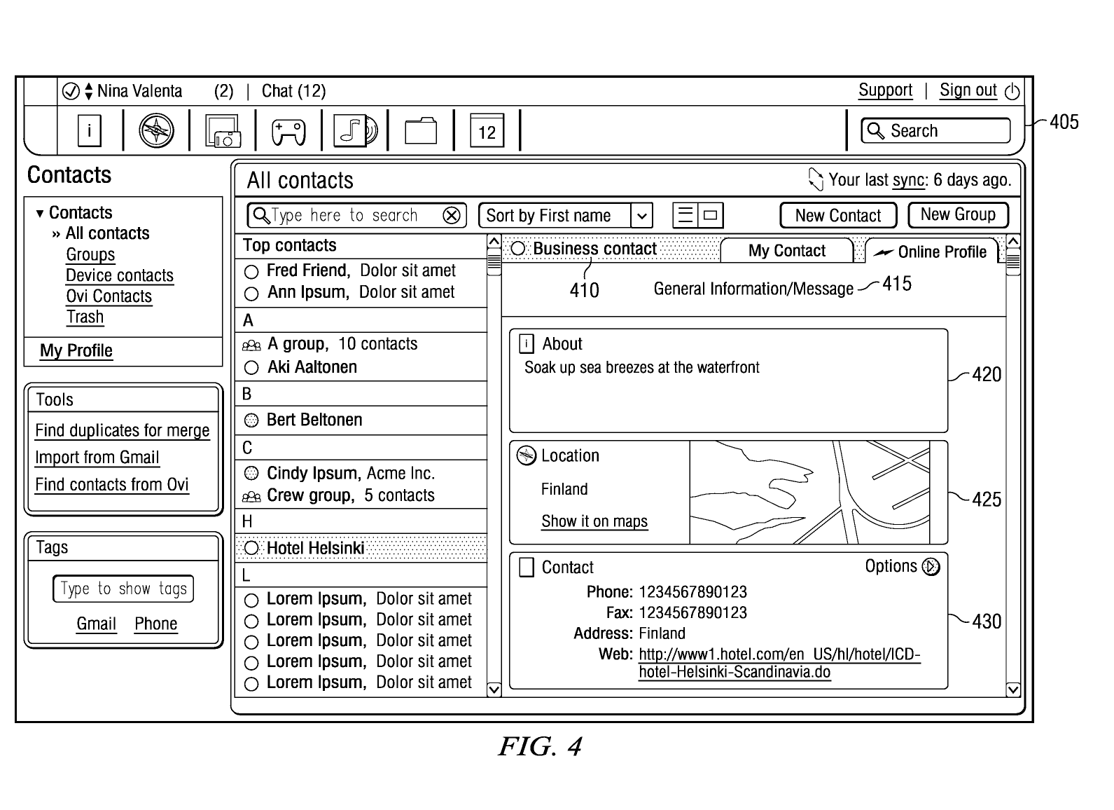

FIG. 4 is a screen view depicting a user interface display operating in accordance with an example embodiment of the invention. In an example embodiment, a user interface 405 is configured to display one or more contacts to provide a user with contact information. For example, the user interface 405 displays a business contact 410. The business contact 410 comprises general information/message 415, more detailed information 420, location information 425, and contact information 430. In an embodiment, the user interface 405 displays an updated business contact 410 and/or a message 415 by employing example embodiments. In such a case, a user is provided with a real time message 415 or business contact 410. In an embodiment, the user interface 405 is located on an electronic device, such as electronic device 305 of FIG. 3. In an alternative embodiment, the user interface 405 is located on a personal computer.

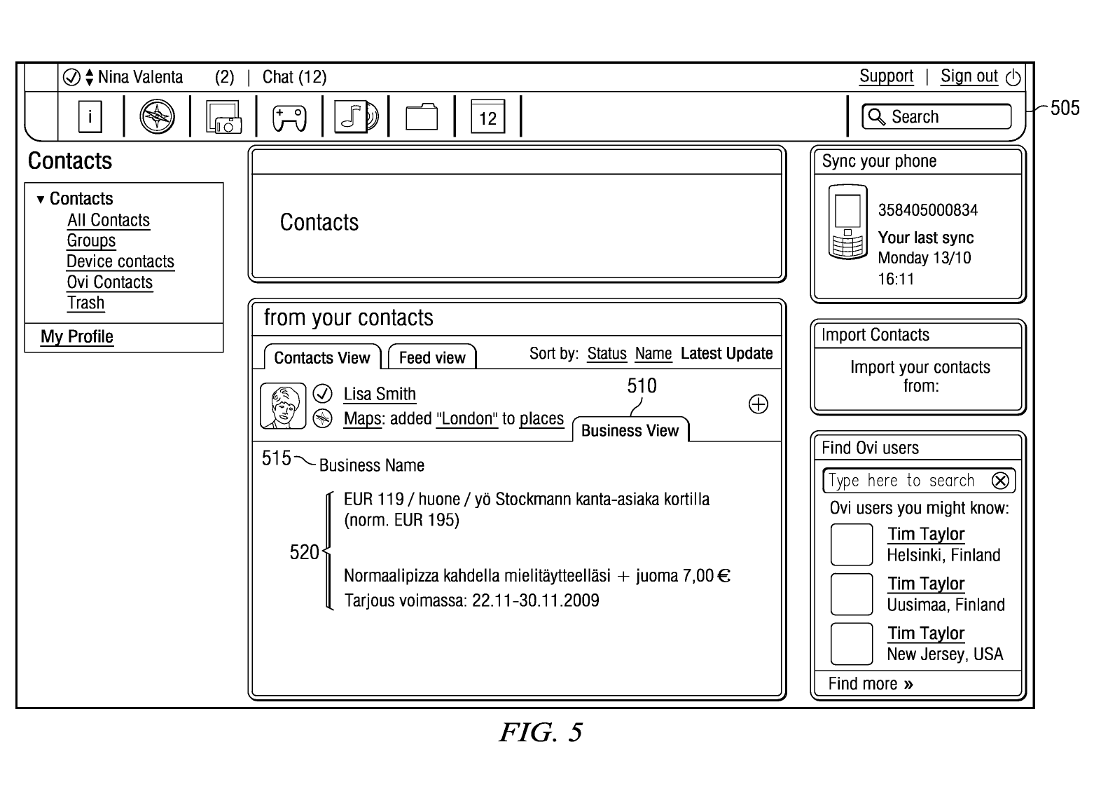

FIG. 5 is a screen view depicting another user interface display operating in accordance with an example embodiment of the invention. In an example embodiment, a user interface 505 is configured to display one or more contacts in a business view 510. For example, the user interface 505 displays a business contact detail 515 and a message 520, such as a promotion. In an embodiment, the business contact detail 515 and the message 520 are updated based at least in part on a user location or interest. In an embodiment, the user may configure whether the business contact detail 515 and/or the message 520 may be updated. Further, the user may configured at what frequency the business contact detail 515 and the messages are to be updated, e.g., daily. In such a case, a user is provided with a real time business contact detail 515 and the message 520 at the desired frequency. In an example embodiment, the user interface 505 is located on a personal computer. In such a case, the business view 510 may be synchronized with an electronic device, such as electronic device 305 of FIG. 3.

FIG. 6 is a flow diagram illustrating an example method 600 for display a contact in accordance with an example embodiment of the invention. Example method 600 may be performed by an electronic device, such as electronic device 305 of FIG. 3.

At 605, an organization contact is updated. In an example embodiment, the processor, such as processor 310 of FIG. 3, is configured to retrieve data that associates an organization with a user, e.g., update a contact associated with the organization based at least in part on a contact change made by the organization. For example, the organization updates a promotion and the processor updates the contact, e.g., a business contact.

At 610, it is determined whether the user configured to receive an updated contact. In an example embodiment, a processor, such as processor 310 of FIG. 3, determines whether the user is to receive updated contacts based at least in part on a user confirmation and/or configuration.

If at 610 it is determined that the user did configure to receive an updated contact, then at 615 the contact is updated. In an example embodiment, the processor is configured to update a contact, such as a business contact, associated with the organization based at least in part on a contact change made by the organization. For example, the organization updates location information or a message, which the processor updates.

At 620, the updated contact is displayed. In an example embodiment, a user interface, such as user interface 315 of FIG. 3, is configured to display the contact, such as the business contact, to the user based at least in part on at least one of the following: geographic location of the user or the updated contact. In an example embodiment, the user interface is further configured to display the updated contact in a business contact on a phonebook. In an embodiment, the user interface 315 is further configured to display the message from the business contact. A technical effect of one or more of the example embodiments disclosed herein is receiving messages from business contacts. The example method 600 ends.

If at 610 it is determined that the user did not configure to receive an updated contact, then the example method 600 ends.

Without in any way limiting the scope, interpretation, or application of the claims appearing below, a technical effect of one or more of the example embodiments disclosed herein may be receiving updated business contacts. Another technical effect of one or more of the example embodiments disclosed herein may be receiving messages from business contacts. Another technical effect of one or more of the example embodiments disclosed herein may be use of a service buddy associated with business contacts.

Embodiments of the present invention may be implemented in software, hardware, application logic or a combination of software, hardware and application logic. The software, application logic and/or hardware may reside on an electronic device, a computer or a service. If desired, part of the software, application logic and/or hardware may reside on an electronic device, part of the software, application logic and/or hardware may reside on a computer, and part of the software, application logic and/or hardware may reside on a service. In an example embodiment, the application logic, software or an instruction set is maintained on any one of various conventional computer-readable media. In the context of this document, a “computer-readable medium” may be any media or means that can contain, store, communicate, propagate or transport the instructions for use by or in connection with an instruction execution system, apparatus, or device. A computer-readable medium may comprise a computer-readable storage medium that may be any media or means that can contain or store the instructions for use by or in connection with an instruction execution system, apparatus, or device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

1. A method for downloading destination addresses associated with a given client device from a server to the client device, the method comprising the steps of:
determining a resource limitation of the client device;
sorting the addresses; and
transmitting a subset of said sorted addresses from the server to the device;
wherein said transmitted sorted address subset is determined by said resource limitation.

2. The method of claim 1, wherein each of the addresses has at least one variable attribute and wherein said sorting step comprises sorting said addresses on their at least one variable attribute.

3. The method of claim 1, wherein each of the addresses has at least variable attribute and wherein said sorting step comprises prioritizing the addresses according to their attributes, wherein said substrate transmitting step comprises transmitting said subset of prioritized addresses from the server to the device in order of their priority, and further wherein the number of addresses in said transmitted subset is determined by said resource limitation.

4. The method of claim 1, wherein each of the addresses has at least one variable attribute and wherein each of the destination addresses corresponds to a user, wherein the at least one variable attribute is a presence attribute indicating a current status of the user corresponding to the address as being one of a plurality of different presence states including at least an online state and further wherein said address subset comprises addresses wherein said presence attribute indicates the user as being online.

5. The method of claim 1, wherein each of the addresses has at least one variable attribute and wherein each of the destination addresses corresponds to a user, wherein the at least one variable attribute is a presence attribute indicating the current status of a user corresponding to the address as being one of a plurality of different presence states selected from the group consisting of online, busy, away and offline and further wherein said address prioritizing step comprises prioritizing addresses having an online presence attribute as highest, addresses having a busy presence attribute second highest, addresses having an away presence attribute third highest and addresses having an offline presence attribute as lowest.

6. The method of claim 1, wherein the client device and the server are interconnected via at least one wireless communications transport and said resource limitation is a speed of said transport.

7. The method of claim 1, wherein the client device comprises a memory allocated for storing a received message, and said resource limitation is a number of messages which can be stored in said allocated memory.

8. The method of claim 1, wherein the client device comprises a memory allocated for storing said transmitted address subset, and said resource limitation is a number of addresses which can be stored in said allocated memory.

9. The method of claim 1, wherein each of the addresses has at least one variable attribute and further comprising the step of updating said transmitted address subset when at least one of the variable attributes of at least one of the destination addresses changes.

10. The method of claim 1, further comprising the step of periodically updating said transmitted address subset.

11. The method of claim 9, wherein each of the addresses has at least one variable attribute and wherein said updating step comprises sorting the addresses according to their attributes and transmitting a subset of said sorted addresses from the server to the device, wherein said transmitted sorted address subset is determined by said resource limitation.

12. The method of claim 1, wherein each of the addresses has at least one variable attribute and wherein each address of said transmitted subset have the same at least one variable attribute.

13. The method of claim 1, wherein each of the addresses has at least one variable attribute and wherein said determined resource limitation is that each address of said transmitted subset shall have the same at least one variable attribute.

14. The method of claim 1, further comprising, prior to said resource limitation determining step, a step of providing a plurality of predefined client device types, each of said predefined types comprising at least one predetermined resource limitation, and further wherein said resource limitation determining step comprises identifying a type of the client device and correlating said identified type with one of said predefined types.

15. The method of claim 1, further comprising, prior to said resource limitation determining step, step of logging the client into the server and wherein said at least one predetermined resource limitation is provided by the client to the server during said login step.

16. The method of claim 15, further comprising, prior to said login step, a step of providing a plurality of predefined client device types, each of said predefined types comprising at least on predetermined resource limitation, wherein said login step comprises the client providing a client device type to the server and further wherein said resource limitation determining step comprises correlating said provided client device type with one of said predefined types.
